(19) United States
(12) Patent Application Publication
(10) Pub. No.: US 2024/0281815 A1
(43) Pub. Date: Aug. 22, 2024

(54) OPTIMIZING ALLOCATION OF TRANSACTION ALERTS

(71) Applicant: International Business Machines Corporation, Armonk, VA (US)

(72) Inventors: Hua Ni, Chantilly, VA (US); Yi-Hui Ma, Mechanicsburg, PA (US); Eugene Irving Kelton, Wake Forest, NC (US)

(73) Assignee: International Business Machines Corporation, Armonk, VA (US)

(21) Appl. No.: 18/111,713

(22) Filed: Feb. 20, 2023

(51) Int. Cl. G06Q 20/40

(52) U.S. Cl. CPC G06Q 20/4016

(57) ABSTRACT

An embodiment includes assigning an entity to a risk category group based on transaction data of a transaction alert associated with the entity, where the transaction alert is concerning potentially suspicious financial activities. The embodiment also identifies a relationship between the entity and another entity based on the transaction data. The embodiment determines a capability of an anti-money laundering (“AML”) analyst, where the capability includes a skill level of the AML analyst. The embodiment generates task allocation data by optimizing an objective function, where the optimizing includes solving the objective function subject to a set of optimization constraints, where the set of optimization constraints includes the risk category group, the relationship between the entities, and the capability of the AML analyst. The embodiment also includes routing the transaction data of the transaction alert to the AML analyst based on the task allocation data.

### BACKGROUND

The present invention relates generally to management of transaction data. More particularly, the present invention relates to a method, system, and computer program for optimizing the allocation of transaction alerts.

Anti-money laundering (AML) analysis is usually performed by financial institutions to prevent, detect, and report money laundering activities. Money laundering refers to activities intended to conceal the identity, source, or destination of money, usually for the purpose of giving a legitimate appearance to earnings from illegal activities. AML analysis of financial transactions of accounts and account holders involves the use of algorithms that identify suspicious accounts or parties that may be engaging in illegal or fraudulent activities. AML analysis may thus be performed to detect whether a customer is in violation of relevant laws and regulations designed to combat money laundering, i.e., detect whether a customer is taking steps to obscure the source of funds that were received from illegal activities. In some instances, financial institutions perform AML analysis in order to comply with applicable AML laws and regulations. For example, financial institutions may rely on AML analysis to meet legal requirements imposed on financial institutions to prevent or report money laundering activities.

### SUMMARY

The illustrative embodiments provide for optimizing allocation of transaction alerts. An embodiment includes assigning a first entity to a risk category group based at least in part on a risk level of the first entity, where the risk level is based at least in part on transaction data of a transaction alert associated with the first entity, and where the transaction alert is concerning potentially suspicious financial activities. The embodiment also includes identifying a relationship between the first entity and a second entity based at least in part on the transaction data. The embodiment also includes determining a capability of an anti-money laundering (“AML”) analyst, where the capability comprises a skill level of the AML analyst. The embodiment also includes generating task allocation data by performing an optimization operation on an objective function, where the optimization operation comprises solving the objective function subject to a set of optimization constraints, where the set of optimization constraints comprises the risk category group, the relationship between the first entity and the second entity, and the capability of the AML analyst. The embodiment also includes routing the transaction data of the transaction alert to the AML analyst based at least in part on the task allocation data. Other embodiments of this aspect include corresponding computer systems, apparatus, and computer programs recorded on one or more computer storage devices, each configured to perform the actions of the embodiment.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment;

FIG. 2 depicts a block diagram of an example alert processing environment in accordance with an illustrative embodiment;

FIG. 3 depicts a block diagram of an example service infrastructure in accordance with an illustrative embodiment;

FIG. 4 depicts a more detailed block diagram of an alert triage module in accordance with an illustrative embodiment;

FIG. 5 depicts a more detailed block diagram of a risk module in accordance with an illustrative embodiment;

FIG. 6 depicts a more detailed block diagram of a network module in accordance with an illustrative embodiment;

FIG. 7 depicts a more detailed block diagram of a resource module in accordance with an illustrative embodiment;

FIG. 8 depicts a more detailed block diagram of an optimization module in accordance with an illustrative embodiment;

FIG. 9 depicts a flowchart of an example process for optimizing the allocation of transaction alerts in accordance with an illustrative embodiment; and

FIG. 10 depicts a flowchart of an example process for generating task allocation data in accordance with an illustrative embodiment.

### DETAILED DESCRIPTION

One of the main issues with many Anti-Money Laundering (AML) systems is producing alerts with high percentage of false positives. Also, current AML triage systems still require strategy and decision as to how to operationalize the process. In AML alerts detection and triage processes, manual review is still an essential task and there are many factors to be considered based on different business objectives. For example, the relationship between entities, the skills of the analysts, and the time/cost associated with each alert.

Disclosed embodiments establish an intelligent system that provides guidance for triaging alerts through multiple decision-making processes to satisfy the specified business goal and enables near real-time resource allocation with optimized workflow. Disclosed embodiments incorporate functional independent components and provide a mechanism to optimize multiple business objectives, allow for creation of an integrated, customizable triage workflow that satisfies specified business goals with quantifiable performance measurement.

In some embodiments, a process receives a user input indicative of an objective. The process then specifies a decision variable for allocating transaction alerts among a plurality of analysts. The process also specifies risk category groups, entity relationships, and analyst capabilities as a set of optimization constraints. The process formulates an optimization problem having an objective function representing the objective as a function of the decision variable. The process then solves the optimization problem subject to the set of optimization constraints, the objective, and the cost-based objective function to jointly determine an optimal dispatching policy.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

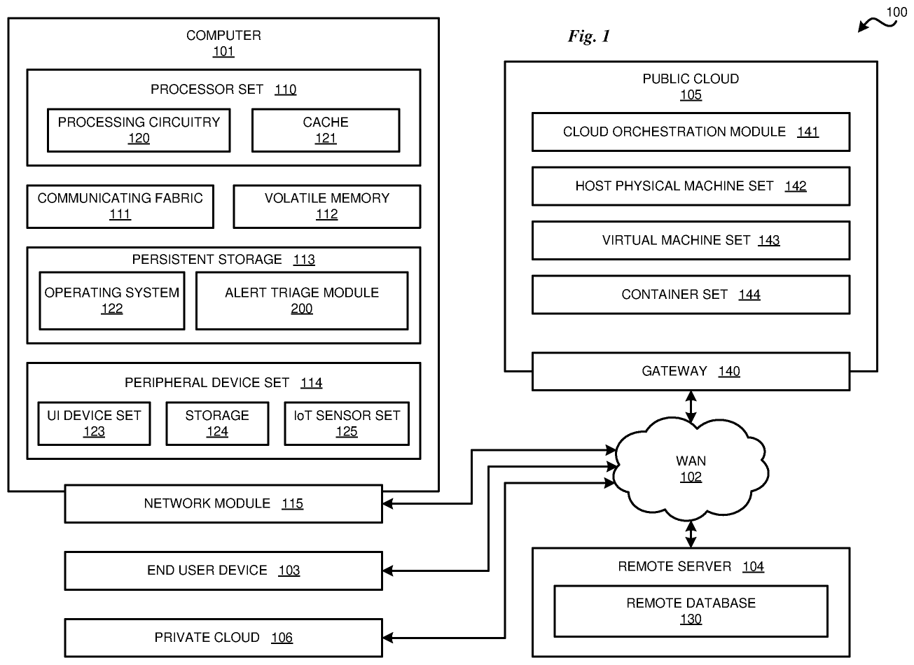

With reference to FIG. 1, this figure depicts a block diagram of a computing environment 100. Computing environment 100 contains an example of an environment for the execution of at least some of the computer code involved in performing the inventive methods, such as an improved alert triage module 200 that performs optimization of the allocation of transaction alerts. In addition to alert triage module 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and alert triage module 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in alert triage module 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in alert triage module 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

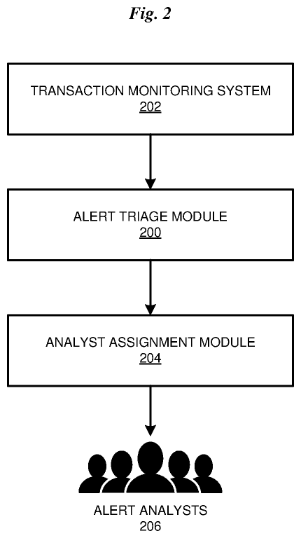

With reference to FIG. 2, this figure depicts a block diagram of an example alert processing environment in accordance with an illustrative embodiment. In the illustrated embodiment, an alert triage module 200 receives transaction alerts from a transaction monitoring system 202 and generates task allocation data for an analyst assignment module 204 that assigns tasks to alert analysts 206.

In an exemplary embodiment, the transaction monitoring system 202 evaluates the condition and health of data for purposes of monitoring transaction data over time, for example, to perform risk assessment, anti-money laundering (AML), and/or fraud detection. In one or more embodiments, the transaction monitoring system 202 outputs transaction alert data for transaction alerts to the alert triage module 200.

In some embodiments, the transaction alert data from the transaction monitoring system 202 comprises transaction data and associated metadata representative of entities, accounts, related transactions, claims, events, payment history, etc. In some embodiments, the transaction monitoring system 202 determines if there is a transaction risk or determines the risk of a money laundering scheme or other fraud. In some such embodiments, the transaction alert data from the transaction monitoring system 202 comprises metadata indicative of the determined level of risk. determined to be associated with each transaction alert.

In the illustrated embodiment, the alert triage module 200 extracts entities from the received transaction alert data and associates each entity with one of a plurality of risk category groups depending on the level of risk. The alert triage module 200 also identifies relationships between the entities, such as entities that have transactions together or other data that may indicate that two entities have some level of familiarity with each other. The alert triage module 200 also determines the capability of alert analysts 206 who will be analyzing the alerts. Typically, a pool of analysts will include analysts of varying degree of skill and experience. Such skill and experience information for each of the alert analysts 206 will be gathered to help match the skill of the alert analysts 206 with the complexity of the transactions being reviewed.

The alert triage module 200 generates task allocation data by performing an optimization operation on an objective function, where the optimization operation solves the objective function subject to a set of optimization constraints, such as the risk category group, the relationships between the entities, and the capabilities of the AML analysts. The task allocation data includes an optimized assignment list for each of the alert analysts 206. The analyst assignment module 204 receives the task allocation data and outputs reports to the alert analysts 206 indicative of their assignments for reviewing transactions. For example, the alert analysts 206 may generate work schedules, calendar reminders, assignment reports, or other such outputs. The alert triage module 200 also routes the transaction data to the analyst assignment module 204 so it can be distributed to the alert analysts 206.

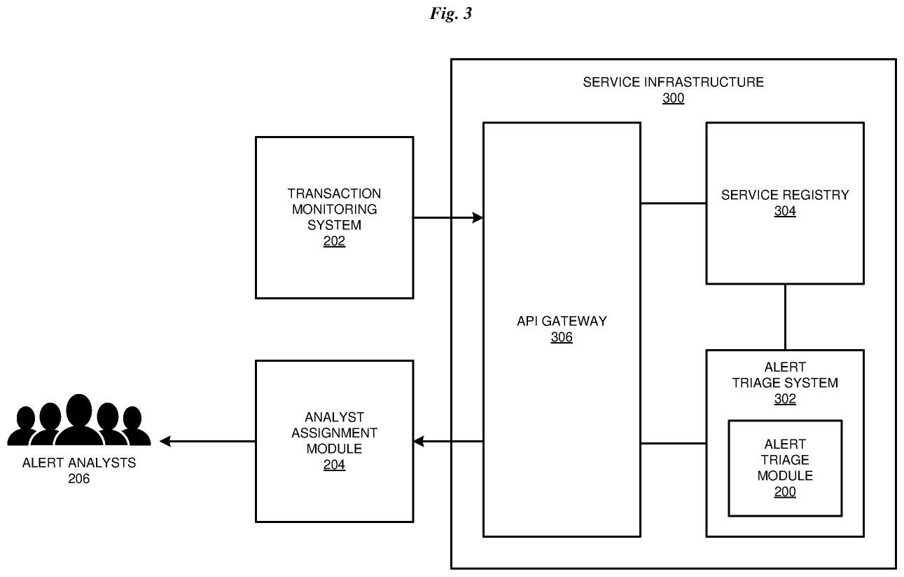

With reference to FIG. 3, this figure depicts a block diagram of an example service infrastructure 300 in accordance with an illustrative embodiment. In the illustrated embodiment, the service infrastructure 300 includes an alert triage system 302. In an embodiment, the alert triage system 302 is an example of the computer 101 of FIG. 1 and includes the alert triage module 200 of FIG. 1.

In the illustrated embodiment, the service infrastructure 300 provides services and service instances to receive transaction alerts from the transaction monitoring system 202 and generate task allocation data for the analyst assignment module 204 that assigns tasks to alert analysts 206. The transaction monitoring system 202 and the analyst assignment module 204 communicate with service infrastructure 300 via an API gateway 306. In various embodiments, service infrastructure 300 and its associated alert triage system 302 serve multiple users and multiple tenants. A tenant is a group of users (e.g., a company) who share a common access with specific privileges to the software instance. Service infrastructure 300 ensures that tenant specific data is isolated from other tenants.

In the illustrated embodiment, service infrastructure 300 includes a service registry 304. In some embodiments, the alert triage system 302 is a virtual machine and the service registry 304 looks up service instances of alert triage system 302 in response to a service lookup request such as one from API gateway 306 in response to a service request from the transaction monitoring system 202 or the analyst assignment module 204. For example, in some embodiments, the service registry 304 looks up service instances of alert triage system 302 in response to requests related to assigning transaction alerts to the alert analysts 206.

In some embodiments, service registry 304 maintains information about the status or health of each service instance including performance information associated each of the service instances. In some such embodiments, such information may include various types of performance characteristics of a given service instance (e.g., cache metrics, etc.) and records of updates.

In some embodiments, the transaction monitoring system 202 and the analyst assignment module 204 connect with API gateway 306 via any suitable network or combination of networks such as the Internet, etc. and uses any suitable communication protocols such as Wi-Fi, Bluetooth, etc. Service infrastructure 300 may be built on the basis of cloud computing. API gateway 306 provides access to client applications like the alert triage module 200. API gateway 306 receives service requests issued by client applications and creates service lookup requests based on service requests. As a non-limiting example, in an embodiment, the transaction monitoring system 202 or the analyst assignment module 204 executes a routine to initiate interaction with the alert triage module 200. For instance, in some embodiments, a user accesses the alert triage module 200 directly using a command line or GUI. Also, in some embodiments, the user accesses the alert triage module 200 indirectly through the use of a web application that interacts with the alert triage module 200 via the API gateway 306.

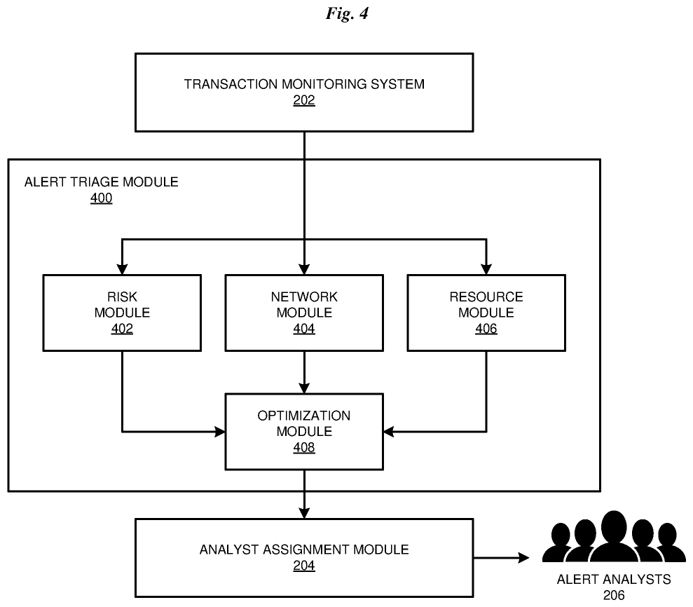

With reference to FIG. 4, this figure depicts a more detailed block diagram of an alert triage module 400 in accordance with an illustrative embodiment. In a particular embodiment, the example alert triage module 400 is an example of alert triage module 200 of FIGS. 1-3.

In the illustrated embodiment, the alert triage module 400 comprises a risk module 402, a network module 404, a resource module 406, and a optimization module 408. In alternative embodiments, the alert triage module 400 can include some or all of the functionality described herein but grouped differently into one or more systems or modules. In some embodiments, the functionality described herein is distributed among a plurality of systems, which can include combinations of software and/or hardware-based systems, for example Application-Specific Integrated Circuits (ASICs), computer programs, or smart phone applications.

In the illustrated embodiment, the alert triage module 200 receives transaction alerts from a transaction monitoring system 202 and generates task allocation data for an analyst assignment module 204 that assigns tasks to alert analysts 206. The transaction monitoring system 202 evaluates the condition and health of data for purposes of monitoring transaction data over time, for example, to perform risk assessment, anti-money laundering (AML), and/or fraud detection. In one or more embodiments, the transaction monitoring system 202 outputs transaction alert data for transaction alerts to the alert triage module 400.

In some embodiments, the transaction alert data from the transaction monitoring system 202 comprises transaction data and associated metadata representative of entities, accounts, related transactions, claims, events, payment history, etc. In some embodiments, the transaction monitoring system 202 determines if there is a transaction risk or determines the risk of a money laundering scheme or other fraud. In some such embodiments, the transaction alert data from the transaction monitoring system 202 comprises metadata indicative of the determined level of risk. determined to be associated with each transaction alert.

In the illustrated embodiment, the risk module 402 extracts entities from the received transaction alert data and associates each entity with one of a plurality of risk category groups depending on the level of risk. The network module 404 also identifies relationships between the entities, such as entities that have transactions together or other data that may indicate that two entities have some level of familiarity with each other. The resource module 406 also determines the capability of alert analysts 206 who will be analyzing the alerts. Typically, a pool of analysts will include analysts of varying degree of skill and experience. Such skill and experience information for each of the alert analysts 206 will be gathered to help match the skill of the alert analysts 206 with the complexity of the transactions being reviewed.

The optimization module 408 generates task allocation data by performing an optimization operation on an objective function, where the optimization operation solves the objective function subject to a set of optimization constraints, such as the risk category groups from the risk module 402, the relationships between the entities from the network module 404, and the capabilities of the AML analysts from the resource module 406. The task allocation data includes an optimized assignment list for each of the alert analysts 206. The analyst assignment module 204 receives the task allocation data and outputs reports to the alert analysts 206 indicative of their assignments for reviewing transactions. For example, the alert analysts 206 may generate work schedules, calendar reminders, assignment reports, or other such outputs. The alert triage module 400 also routes the transaction data to the analyst assignment module 204 so it can be distributed to the alert analysts 206.

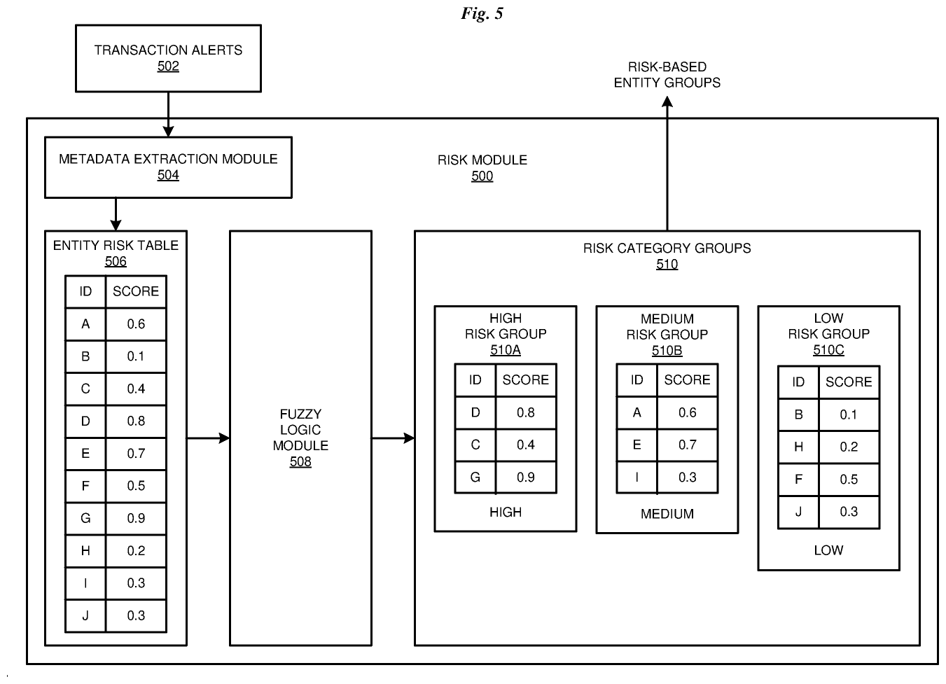

With reference to FIG. 5, this figure depicts a more detailed block diagram of a risk module 500 in accordance with an illustrative embodiment. In a particular embodiment, the example risk module 500 is an example of risk module 402 of FIG. 4.

In the illustrated embodiment, the risk module 500 comprises a metadata extraction module 504 that receives transaction alerts transaction alerts 502. The transaction alerts 502 include risk scores as metadata. The metadata extraction module 504 extracts the risk scores for entities A-J associated with the received transaction alerts 502. A fuzzy logic module 508 then groups the entities into risk category groups 510, which include high risk group 510A, medium risk group 510B, and low risk group 510C. In some embodiments, the fuzzy logic module 508 groups the entities according to risk score. In some embodiments, the fuzzy logic module 508 provides the flexibility to allow a subject matter expert (SME) to incorporate other factors for the fuzzy logic module 508 to consider when grouping the entities. For example, the SME may wish to have the entities grouped differently according to business considerations. While three groups 510A-510C, other numbers of groups may be used.

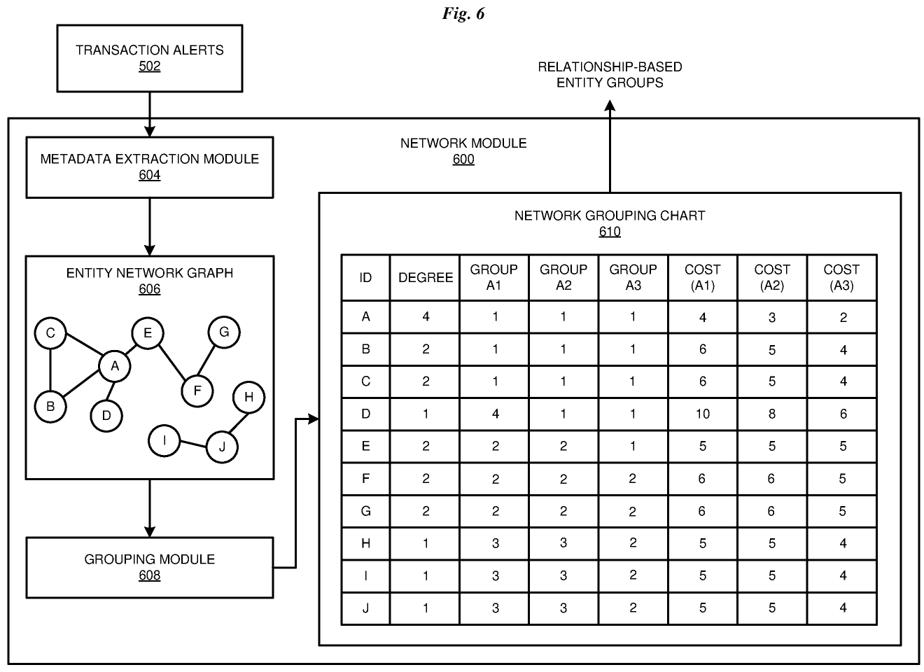

With reference to FIG. 6, this figure depicts a more detailed block diagram of a network module 600 in accordance with an illustrative embodiment. In a particular embodiment, the example network module 600 is an example of network module 404 of FIG. 4.

In the illustrated embodiment, the network module 600 comprises a metadata extraction module 604 that receives transaction alerts transaction alerts 502. The transaction alerts 502 include entities as metadata. The metadata extraction module 604 extracts the entity and transaction information for entities A-J associated with the received transaction alerts 502. The network module 600 identifies the relationships between the entities and generates an entity network graph 606. In some embodiments, the entity network graph 606 includes nodes for each of entities A-J and edges connecting pairs of the nodes, where the nodes are representative of respective entities of the plurality of entities, and wherein the edges are representative of relationships between the entities.

In the illustrated embodiment, a grouping module 608 then evaluates the entity network graph 606 to identify possible groups and associated costs of the entity network graph 606. The grouping module 608 uses known graph optimization techniques to determine potential subgroups and associated costs, which are then assembled into a network grouping chart 610.

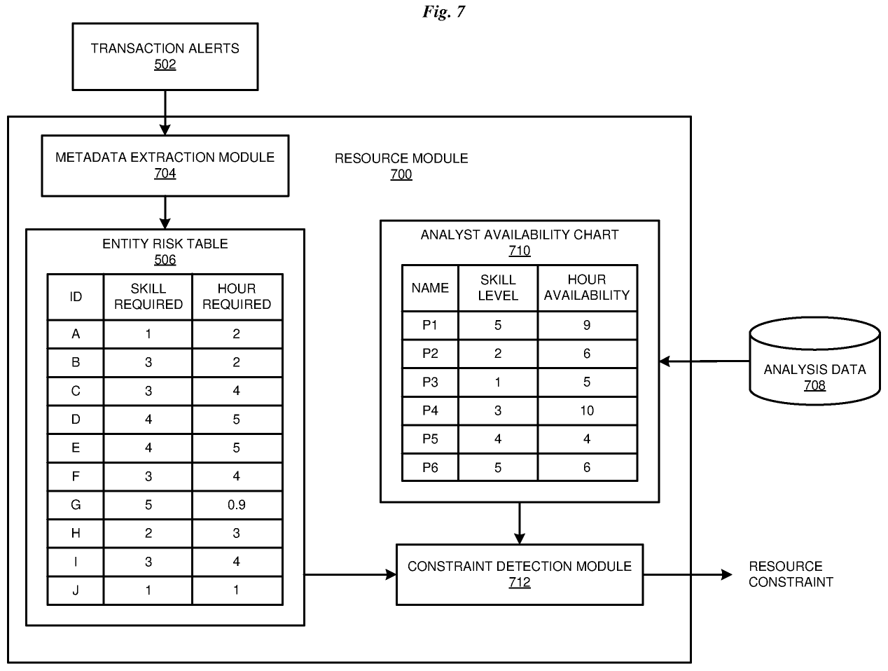

With reference to FIG. 7, this figure depicts a more detailed block diagram of a resource module 700 in accordance with an illustrative embodiment. In a particular embodiment, the example resource module 700 is an example of resource module 406 of FIG. 4.

In the illustrated embodiment, the resource module 700 comprises a metadata extraction module 704 that receives transaction alerts transaction alerts 502. The transaction alerts 502 include information about the type of transaction or alert that needs to be reviewed. The resource module 700 determines a complexity score, for example using a look-up table or a machine-learning model that has been trained to classify tasks according to levels of complexity based on words or phrases in the alert description. The resource module 700 generates a requirements chart 706 that includes a numerical value indicating a level of complexity, for example where a higher value indicates a need for an analyst with a higher skill level.

In the illustrated embodiment, the resource module 700 also has access to analysts data 708, which is used to generate the analyst availability chart 710. The constraint detection module 712 then evaluates the analyst availability chart 710 and the requirements chart 706 and outputs assignment constraints to limit assignments to analysts having the requisite skill level and to prefer analysts having enough availability to minimize cost, i.e., minimize the amount of time until the alert with be evaluated.

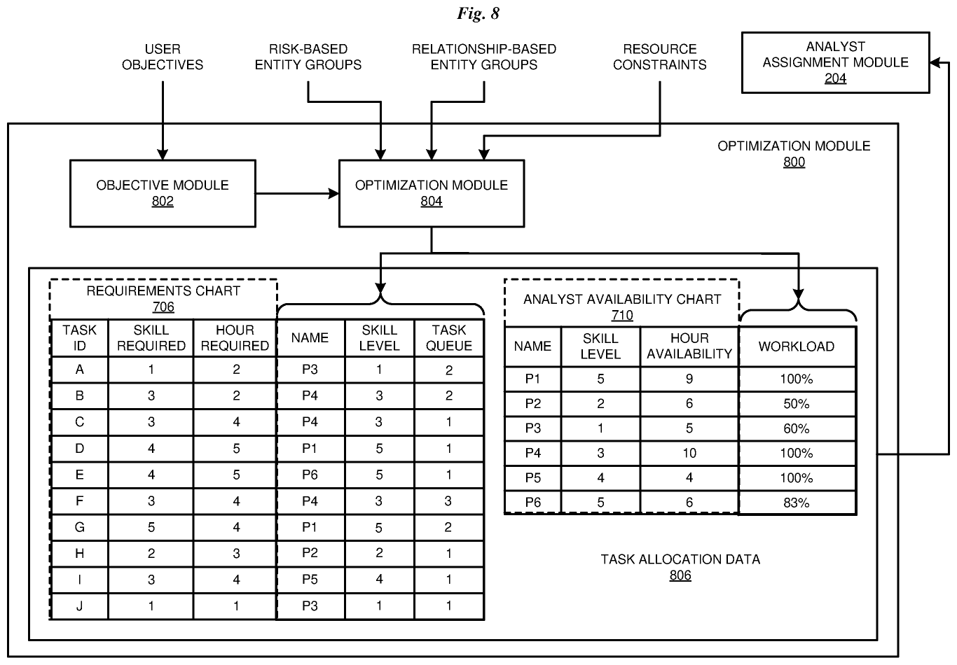

With reference to FIG. 8, this figure depicts a more detailed block diagram of an optimization module 800 in accordance with an illustrative embodiment. In a particular embodiment, the optimization module 800 is an example of optimization module 408 of FIG. 4.

In the illustrated embodiment, the optimization module 800 comprises an objective module 802 and an optimization module 804. The objective module 802 receives a user input indicative of an objective. The objective module 802 allows different business objectives to be selected and the optimization module 804 will apply the risk category groups, entity relationships, and analyst capabilities as a set of optimization constraints. The optimization module 804 formulates an optimization problem having an objective function representing the objective as a function of a decision variable. The optimization module 804 solves the optimization problem subject to the set of optimization constraints, the objective, and the cost-based objective function to jointly determine, for example, an optimal dispatching policy shown as task allocation data 806.

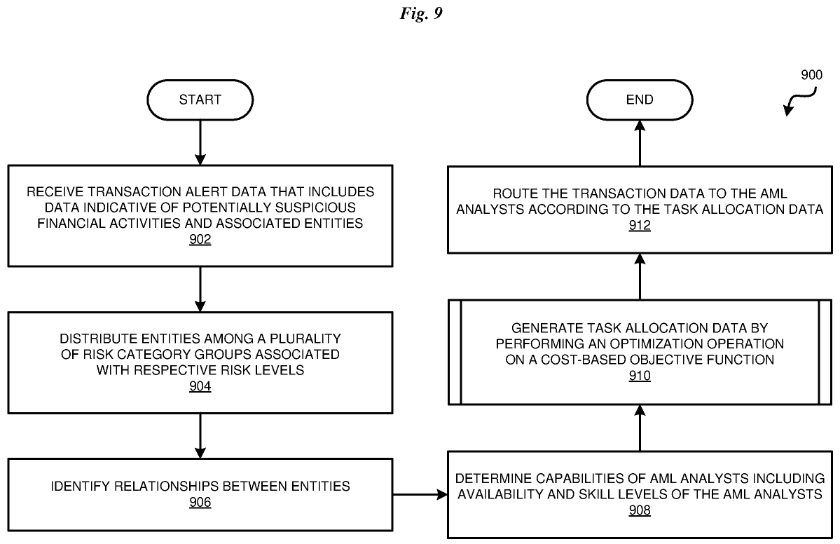

With reference to FIG. 9, this figure depicts a flowchart of an example process 900 for optimizing the allocation of transaction alerts in accordance with an illustrative embodiment. In a particular embodiment, the alert triage module 200 of FIGS. 1-3 or the alert triage module 400 of FIG. 4 carries out the process 900.

At block 902, the process receives transaction alert data that includes data indicative of potentially suspicious financial activities and associated entities. Next, at block 904, the process distributes entities among a plurality of risk category groups associated with respective risk levels. Next, at block 906, the process identifies relationships between entities. Next, at block 908, the process determines capabilities of AML analysts, including availability and skill levels of the AML analysts. Next, at block 910, the process generates task allocation data by performing an optimization operation on a cost-based objective function. Next, at block 912, the process routes the transaction data to the AML analysts according to the task allocation data.

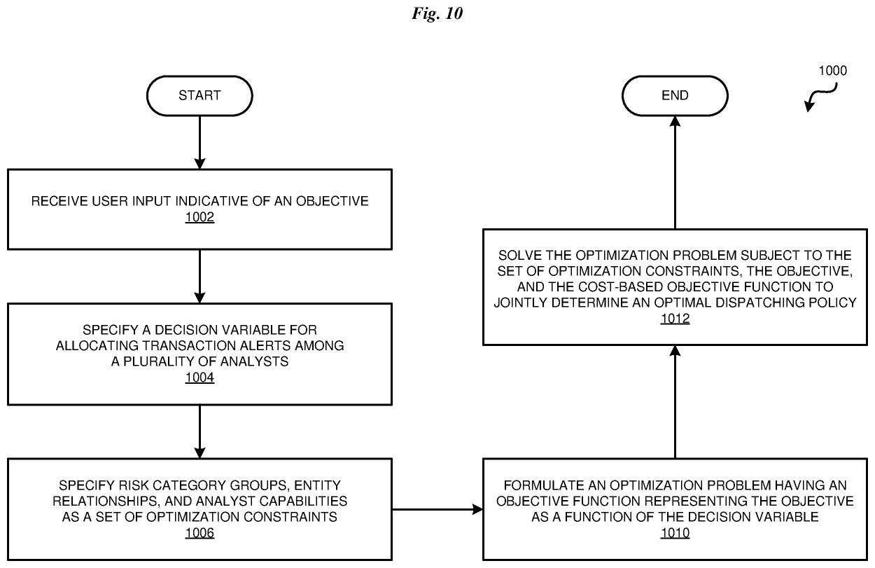

With reference to FIG. 10, this figure depicts a flowchart of an example process 1000 for generating task allocation data in accordance with an illustrative embodiment. In a particular embodiment, the process 1000 is an example of the process at block 910 of FIG. 9. In a particular embodiment, the alert triage module 200 of FIGS. 1-3 or the alert triage module 400 of FIG. 4 carries out the process 1000.

At block 1002, the process receives a user input indicative of an objective. Next, at block 1004, the process specifies a decision variable for allocating transaction alerts among a plurality of analysts. Next, at block 1006, the process specifies risk category groups, entity relationships, and analyst capabilities as a set of optimization constraints. Next, at block 1010, the process formulates an optimization problem having an objective function representing the objective as a function of the decision variable. Next, at block 1012, the process solves the optimization problem subject to the set of optimization constraints, the objective, and the cost-based objective function to jointly determine an optimal dispatching policy.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

The present invention may be a system, a method, and/or a computer program product at any possible technical detail level of integration. The computer program product may include a computer readable storage medium (or media) having computer readable program instructions thereon for causing a processor to carry out aspects of the present invention.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
assigning a first entity to a risk category group based at least in part on a risk level of the first entity, wherein the risk level is based at least in part on transaction data of a transaction alert associated with the first entity, wherein the transaction alert is concerning potentially suspicious financial activities;
identifying a relationship between the first entity and a second entity based at least in part on the transaction data;
determining a capability of an anti-money laundering (“AML”) analyst, wherein the capability comprises a skill level of the AML analyst;
generating task allocation data by performing an optimization operation on an objective function, wherein the optimization operation comprises solving the objective function subject to a set of optimization constraints, wherein the set of optimization constraints comprises the risk category group, the relationship between the first entity and the second entity, and the capability of the AML analyst; and
routing the transaction data of the transaction alert to the AML analyst based at least in part on the task allocation data.

2. The computer-implemented method according to claim 1, further comprising generating the objective function based at least in part on a user-specified objective.

3. The computer-implemented method according to claim 1, wherein the objective function is a cost-based objective function, and wherein the optimization operation comprises minimizing a total cost metric subject to the set of constraints.

4. The computer-implemented method according to claim 1, wherein the transaction alert is one of a plurality of transaction alerts, and wherein the first and second entities are among a plurality of entities associated with the plurality of transaction alerts.

5. The computer-implemented method according to claim 4, wherein the assigning of the first entity to the risk category group further comprises distributing the plurality of entities among a plurality of risk category groups associated with respective risk levels.

6. The computer-implemented method according to claim 5, wherein the distributing of the plurality of entities among the plurality of risk category groups is based at least in part on risk metadata of the transaction data.

7. The computer-implemented method according to claim 4, wherein the identifying of the relationship between the first entity and the second entity further comprises generating a network graph comprising nodes and edges connecting pairs of the nodes, wherein the nodes are representative of respective entities of the plurality of entities, and wherein the edges are representative of relationships between the entities.

8. The computer-implemented method according to claim 7, further comprising identifying a plurality of distinct relationship-based entity groups from the network graph.

9. The computer-implemented method according to claim 1, wherein the determining of the capability of the AML analyst further comprises determining an availability of the AML analyst.

10. A computer program product comprising one or more computer readable storage media, and program instructions collectively stored on the one or more computer readable storage media, the program instructions executable by a processor to cause the processor to perform operations comprising:
assigning a first entity to a risk category group based at least in part on a risk level of the first entity, wherein the risk level is based at least in part on transaction data of a transaction alert associated with the first entity, wherein the transaction alert is concerning potentially suspicious financial activities;
identifying a relationship between the first entity and a second entity based at least in part on the transaction data;
determining a capability of an anti-money laundering (“AML”) analyst, wherein the capability comprises a skill level of the AML analyst;
generating task allocation data by performing an optimization operation on an objective function, wherein the optimization operation comprises solving the objective function subject to a set of optimization constraints, wherein the set of optimization constraints comprises the risk category group, the relationship between the first entity and the second entity, and the capability of the AML analyst; and
routing the transaction data of the transaction alert to the AML analyst based at least in part on the task allocation data.

11. The computer program product of claim 10, wherein the stored program instructions are stored in a computer readable storage device in a data processing system, and wherein the stored program instructions are transferred over a network from a remote data processing system.

12. The computer program product of claim 10, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

13. The computer program product of claim 10, further comprising generating the objective function based at least in part on a user-specified objective.

14. The computer program product of claim 10, wherein the objective function is a cost-based objective function, and wherein the optimization operation comprises minimizing a total cost metric subject to the set of constraints.

15. The computer program product of claim 10, wherein the transaction alert is one of a plurality of transaction alerts, and wherein the first and second entities are among a plurality of entities associated with the plurality of transactions.

16. The computer program product of claim 15, wherein the assigning of the first entity to the risk category group further comprises distributing the plurality of entities among a plurality of risk category groups associated with respective risk levels.

17. A computer system comprising a processor and one or more computer readable storage media, and program instructions collectively stored on the one or more computer readable storage media, the program instructions executable by the processor to cause the processor to perform operations comprising:
assigning a first entity to a risk category group based at least in part on a risk level of the first entity, wherein the risk level is based at least in part on transaction data of a transaction alert associated with the first entity, wherein the transaction alert is concerning potentially suspicious financial activities;
identifying a relationship between the first entity and a second entity based at least in part on the transaction data;
determining a capability of an anti-money laundering (“AML”) analyst, wherein the capability comprises a skill level of the AML analyst;
generating task allocation data by performing an optimization operation on an objective function, wherein the optimization operation comprises solving the objective function subject to a set of optimization constraints, wherein the set of optimization constraints comprises the risk category group, the relationship between the first entity and the second entity, and the capability of the AML analyst; and
routing the transaction data of the transaction alert to the AML analyst based at least in part on the task allocation data.

18. The computer system of claim 17, further comprising generating the objective function based at least in part on a user-specified objective.

19. The computer system of claim 17, wherein the objective function is a cost-based objective function, and wherein the optimization operation comprises minimizing a total cost metric subject to the set of constraints.

20. The computer system of claim 17, wherein the transaction alert is one of a plurality of transaction alerts, and wherein the first and second entities are among a plurality of entities associated with the plurality of transactions.
